(19) United States
(12) Patent Application Publication
(10) Pub. No.: US 2024/0232797 A1
(43) Pub. Date: Jul. 11, 2024

(54) SYSTEMS, METHODS, AND APPARATUSES FOR ELECTRONICALLY, INITIATING, TRACKING AND COMPLETING RESOURCE REPLENISHMENTS WITH A NETWORK

(71) Applicant: BANK OF AMERICA CORPORATION, Charlotte, NC (US)

(72) Inventors: Michael G. Horstman, Chicago, IL (US); Manu Jacob Kurian, Dallas, TX (US)

(73) Assignee: BANK OF AMERICA CORPORATION, Charlotte, NC (US)

(21) Appl. No.: 18/093,702

(22) Filed: Jan. 5, 2023

(51) Int. Cl. G06Q 10/087

(52) U.S. Cl. CPC G06Q 10/087

(57) ABSTRACT

Systems, computer program products, and methods are described herein for electronically, initiating, tracking and completing resource replenishments with a network. The method includes receiving a resource indicator relating to a resource at location(s). The resource indicator includes information relating to an inventory of the resource at each of the one or more locations. The method also includes determining a resource replenishment action is needed for at least one of the one or more locations based on the resource indicator. The resource replenishment action is needed in an instance in which the inventory of the resource is below an inventory threshold. The method further includes causing an execution of the resource replenishment action in response to determining the resource replenishment action is needed. The resource replenishment action is executed for each of the one or more locations in which the inventory of the resource is below the inventory threshold.

### TECHNOLOGICAL FIELD

Example embodiments of the present disclosure relate generally to electronically, managing resource replenishments and, more particularly, to electronically, initiating, tracking and completing resource replenishments with a network.

### BACKGROUND

Distributed resource procurement and management can be difficult across multiple locations, especially in real-time. Through applied effort, ingenuity, and innovation, many of these identified problems have been solved by developing solutions that are included in embodiments of the present disclosure, many examples of which are described in detail herein.

### SUMMARY

The following presents a simplified summary of one or more embodiments of the present disclosure, in order to provide a basic understanding of such embodiments. This summary is not an extensive overview of all contemplated embodiments and is intended to neither identify key or critical elements of all embodiments nor delineate the scope of any or all embodiments. Its sole purpose is to present some concepts of one or more embodiments of the present disclosure in a simplified form as a prelude to the more detailed description that is presented later.

In an example embodiment, a system for tracking and completing resource replenishments with a network is provided. The system includes at least one non-transitory storage device and at least one processing device coupled to the at least one non-transitory storage device. The at least one processing device is configured to receive a resource indicator relating to a resource at one or more locations. The resource indicator includes information relating to an inventory of the resource at each of the one or more locations. The at least one processing device is also configured to determine a resource replenishment action is needed for at least one of the one or more locations based on the resource indicator. The resource replenishment action is needed in an instance in which the inventory of the resource is below an inventory threshold for at least one of the one or more locations. The at least one processing device is further configured to cause an execution of the resource replenishment action in response to determining the resource replenishment action is needed. The resource replenishment action is executed for each of the one or more locations in which the inventory of the resource is below the inventory threshold.

In various embodiments, the at least one processing device is configured to receive a replenishment indicator that indicates the resource has been replenished for at least one of the one or more locations. In various embodiments, the replenishment indicator includes an updated value of the inventory for one or more of the one or more locations.

In various embodiments, the at least one processing device is configured to determine a replenishment order for at least two of the one or more locations based on the inventory of the resource for each of the at least two of the one or more locations with the replenishment order indicating a ranking of priority for replenishment among the at least two of the one or more locations.

In various embodiments, the at least one processing device is configured to determine a replenishment value for one of the one or more locations based on a comparison of the inventory of the resource for the one of the one or more locations and the inventory threshold for the one of the one or more locations. In various embodiments, the resource replenishment action includes an alert to one or more suppliers that a replenishment is needed at least one of the one or more locations. In various embodiments, the resource indicator comprises a real-time value of the inventory of the resource at the one or more locations.

In another example embodiment, a computer program product for tracking and completing resource replenishments with a network is provided. The computer program product includes at least one non-transitory computer-readable medium having computer-readable program code portions embodied therein. The computer-readable program code portions include an executable portion configured to receive a resource indicator relating to a resource at one or more locations. The resource indicator includes information relating to an inventory of the resource at each of the one or more locations. The computer-readable program code portions also include an executable portion configured to determine a resource replenishment action is needed for at least one of the one or more locations based on the resource indicator. The resource replenishment action is needed in an instance in which the inventory of the resource is below an inventory threshold for at least one of the one or more locations. The computer-readable program code portions further include an executable portion configured to cause an execution of the resource replenishment action in response to determining the resource replenishment action is needed. The resource replenishment action is executed for each of the one or more locations in which the inventory of the resource is below the inventory threshold.

In various embodiments, the computer program product further includes an executable portion configured to receive a replenishment indicator that indicates the resource has been replenished for at least one of the one or more locations. In various embodiments, the replenishment indicator includes an updated value of the inventory for one or more of the one or more locations.

In various embodiments, the computer program product further includes an executable portion configured to determine a replenishment order for at least two of the one or more locations based on the inventory of the resource for each of the at least two of the one or more locations with the replenishment order indicating a ranking of priority for replenishment among the at least two of the one or more locations.

In various embodiments, the computer program product further includes an executable portion configured to determine a replenishment value for one of the one or more locations based on a comparison of the inventory of the resource for the one of the one or more locations and the inventory threshold for the one of the one or more locations.

In various embodiments, the resource replenishment action includes an alert to one or more suppliers that a replenishment is needed at least one of the one or more locations. In various embodiments, the resource indicator includes a real-time value of the inventory of the resource at the one or more locations.

In still another example embodiment, a computer-implemented method for tracking and completing resource replenishments with a network is provided. The method includes receiving a resource indicator relating to a resource at one or more locations. The resource indicator includes information relating to an inventory of the resource at each of the one or more locations. The method also includes determining a resource replenishment action is needed for at least one of the one or more locations based on the resource indicator. The resource replenishment action is needed in an instance in which the inventory of the resource is below an inventory threshold for at least one of the one or more locations. The method further includes causing an execution of the resource replenishment action in response to determining the resource replenishment action is needed. The resource replenishment action is executed for each of the one or more locations in which the inventory of the resource is below the inventory threshold.

In various embodiments, the method also includes receiving a replenishment indicator that indicates the resource has been replenished for at least one of the one or more locations with the replenishment indicator including an updated value of the inventory for one or more of the one or more locations. In various embodiments, the method also includes determining a replenishment order for at least two of the one or more locations based on the inventory of the resource for each of the at least two of the one or more locations with the replenishment order indicating a ranking of priority for replenishment among the at least two of the one or more locations.

In various embodiments, the method also includes determining a replenishment value for one of the one or more locations based on a comparison of the inventory of the resource for the one of the one or more locations and the inventory threshold for the one of the one or more locations. In various embodiments, the resource replenishment action includes an alert to one or more suppliers that a replenishment is needed at least one of the one or more locations. In various embodiments, the resource indicator includes a real-time value of the inventory of the resource at the one or more locations.

The features, functions, and advantages that have been discussed may be achieved independently in various embodiments of the present disclosure or may be combined with yet other embodiments, further details of which can be seen with reference to the following description and drawings.

### BRIEF DESCRIPTION OF THE DRAWINGS

Having described certain example embodiments of the present disclosure in general terms above, reference will now be made to the accompanying drawings. The components illustrated in the figures may or may not be present in certain embodiments described herein. Some embodiments may include fewer (or more) components than those shown in the figures.

FIGS. 1A-1C illustrates technical components of an exemplary distributed computing environment for electronically, initiating, tracking and completing resource replenishments with a network, in accordance with various embodiments of the present disclosure; and

FIG. 2 illustrates a process flow for electronically, initiating, tracking and completing resource replenishments with a network, in accordance with various embodiments of the present disclosure.

### DETAILED DESCRIPTION

Embodiments of the present disclosure will now be described more fully hereinafter with reference to the accompanying drawings, in which some, but not all, embodiments of the disclosure are shown. Indeed, the various inventions may be embodied in many different forms and should not be construed as limited to the embodiments set forth herein; rather, these embodiments are provided so that this disclosure will satisfy applicable legal requirements. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Furthermore, when it is said herein that something is “based on” something else, it may be based on one or more other things as well. In other words, unless expressly indicated otherwise, as used herein “based on” means “based at least in part on” or “based at least partially on.” Like numbers refer to like elements throughout.

As used herein, an “entity” may be any institution employing information technology resources and particularly technology infrastructure configured for processing large amounts of data. Typically, these data can be related to the people who work for the organization, its products or services, the customers or any other aspect of the operations of the organization. As such, the entity may be any institution, group, association, financial institution, establishment, company, union, authority or the like, employing information technology resources for processing large amounts of data.

As described herein, a “user” may be an individual associated with an entity. As such, in some embodiments, the user may be an individual having past relationships, current relationships or potential future relationships with an entity. In some embodiments, the user may be an employee (e.g., an associate, a project manager, an IT specialist, a manager, an administrator, an internal operations analyst, or the like) of the entity or enterprises affiliated with the entity.

As used herein, a “user interface” may be a point of human-computer interaction and communication in a device that allows a user to input information, such as commands or data, into a device, or that allows the device to output information to the user. For example, the user interface includes a graphical user interface (GUI) or an interface to input computer-executable instructions that direct a processor to carry out specific functions. The user interface typically employs certain input and output devices such as a display, mouse, keyboard, button, touchpad, touch screen, microphone, speaker, LED, light, joystick, switch, buzzer, bell, and/or other user input/output device for communicating with one or more users.

As used herein, an “engine” may refer to core elements of an application, or part of an application that serves as a foundation for a larger piece of software and drives the functionality of the software. In some embodiments, an engine may be self-contained, but externally-controllable code that encapsulates powerful logic designed to perform or execute a specific type of function. In one aspect, an engine may be underlying source code that establishes file hierarchy, input and output methods, and how a specific part of an application interacts or communicates with other software and/or hardware. The specific components of an engine may vary based on the needs of the specific application as part of the larger piece of software. In some embodiments, an engine may be configured to retrieve resources created in other applications, which may then be ported into the engine for use during specific operational aspects of the engine. An engine may be configurable to be implemented within any general purpose computing system. In doing so, the engine may be configured to execute source code embedded therein to control specific features of the general purpose computing system to execute specific computing operations, thereby transforming the general purpose system into a specific purpose computing system.

As used herein, “authentication credentials” may be any information that can be used to identify of a user. For example, a system may prompt a user to enter authentication information such as a username, a password, a personal identification number (PIN), a passcode, biometric information (e.g., iris recognition, retina scans, fingerprints, finger veins, palm veins, palm prints, digital bone anatomy/structure, and positioning (distal phalanges, intermediate phalanges, proximal phalanges, and the like)), an answer to a security question, a unique intrinsic user activity, such as making a predefined motion with a user device. This authentication information may be used to authenticate the identity of the user (e.g., determine that the authentication information is associated with the account) and determine that the user has authority to access an account or system. In some embodiments, the system may be owned or operated by an entity. In such embodiments, the entity may employ additional computer systems, such as authentication servers, to validate and certify resources inputted by the plurality of users within the system. The system may further use its authentication servers to certify the identity of users of the system, such that other users may verify the identity of the certified users. In some embodiments, the entity may certify the identity of the users. Furthermore, authentication information or permission may be assigned to or required from a user, application, computing node, computing cluster, or the like to access stored data within at least a portion of the system.

It should also be understood that “operatively coupled,” as used herein, means that the components may be formed integrally with each other, or may be formed separately and coupled together. Furthermore, “operatively coupled” means that the components may be formed directly to each other, or to each other with one or more components located between the components that are operatively coupled together. Furthermore, “operatively coupled” may mean that the components are detachable from each other, or that they are permanently coupled together. Furthermore, operatively coupled components may mean that the components retain at least some freedom of movement in one or more directions or may be rotated about an axis (i.e., rotationally coupled, pivotally coupled). Furthermore, “operatively coupled” may mean that components may be electronically connected and/or in fluid communication with one another.

As used herein, an “interaction” may refer to any communication between one or more users, one or more entities or institutions, one or more devices, nodes, clusters, or systems within the distributed computing environment described herein. For example, an interaction may refer to a transfer of data between devices, an accessing of stored data by one or more nodes of a computing cluster, a transmission of a requested task, or the like.

As used herein, “determining” may encompass a variety of actions. For example, “determining” may include calculating, computing, processing, deriving, investigating, ascertaining, and/or the like. Furthermore, “determining” may also include receiving (e.g., receiving information), accessing (e.g., accessing data in a memory), and/or the like. Also, “determining” may include resolving, selecting, choosing, calculating, establishing, and/or the like. Determining may also include ascertaining that a parameter matches a predetermined criterion, including that a threshold has been met, passed, exceeded, and so on.

Scheduling stock replenishment can be difficult as resource order is often not uniform or completely predictable. A merchant location can have many different resources that must all be monitored independently. Additionally, a given resource are often offered at multiple locations and serviced periodically by a vendor or supplier. As such, resource stocking can be difficult to maintain at the desired level without requiring large scale user interaction and scheduling servicing of multiple locations make it difficult to maintain resource stocking across multiple locations.

Various embodiments of the present disclosure allow for resource management of a resource across multiple locations. To do this, the system receives a resource indicator that corresponds to the amount of a given resource at each of one or more locations. The resource indicator is compared to a resource inventory for each of the locations to determine any locations that need to be replenished. In response to determining one or more locations need to be replenished, a resource replenishment action can be executed. The resource replenishment action may be an alert to a supplier that a replenishment is necessary and/or an automated replenishment order of the resource for one or more locations. The present disclosure provides a solution to issues with large scale resource management and procurement. Namely, various embodiments of the present disclosure provide automated resource replenishment across a network.

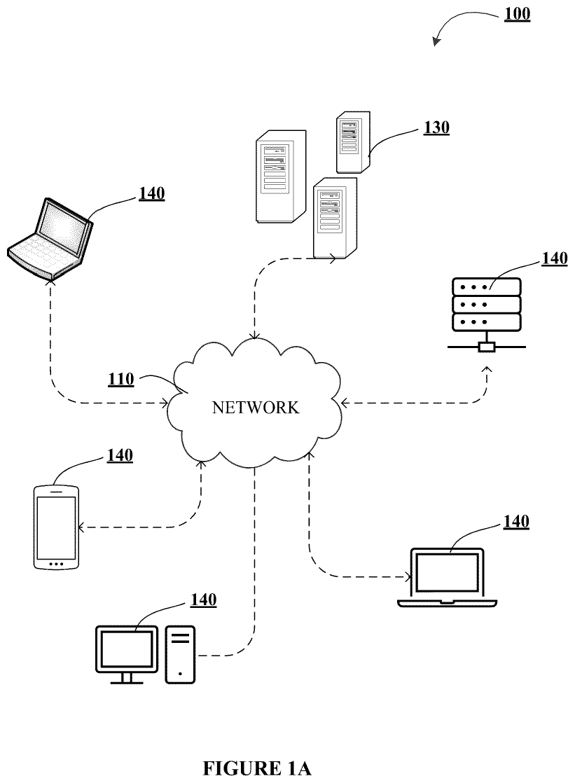

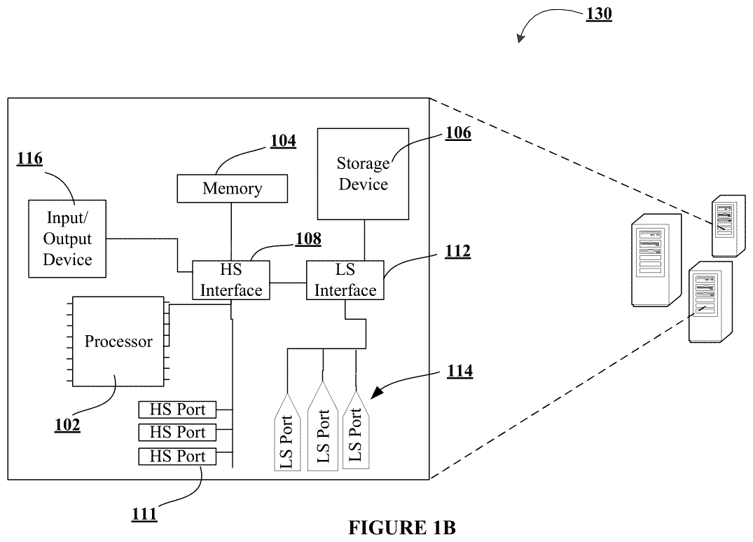

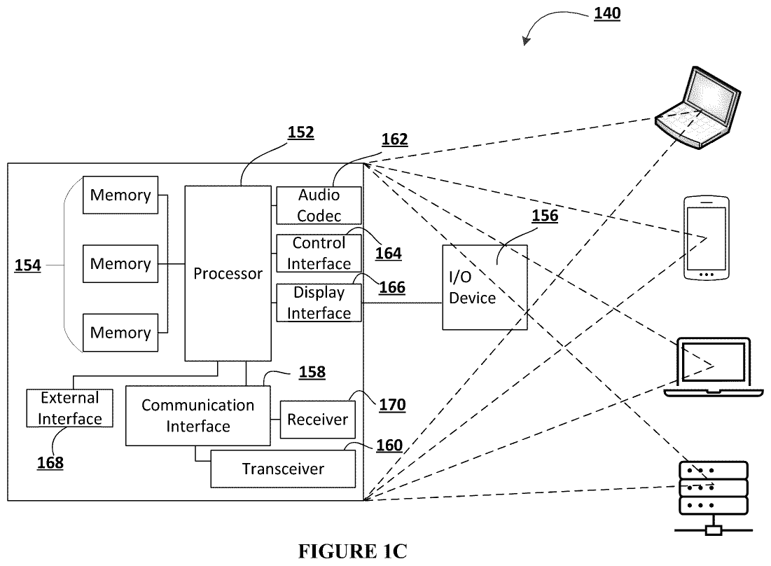

FIGS. 1A-1C illustrate technical components of an exemplary distributed computing environment for electronically, initiating, tracking and completing resource replenishments with a network, in accordance with an embodiment of the disclosure. As shown in FIG. 1A, the distributed computing environment 100 contemplated herein may include a system 130 (i.e., an authentication credential verification), an end-point device(s) 140, and a network 110 over which the system 130 and end-point device(s) 140 communicate therebetween. FIG. 1A illustrates only one example of an embodiment of the distributed computing environment 100, and it will be appreciated that in other embodiments one or more of the systems, devices, and/or servers may be combined into a single system, device, or server, or be made up of multiple systems, devices, or servers. Also, the distributed computing environment 100 may include multiple systems, same or similar to system 130, with each system providing portions of the necessary operations (e.g., as a server bank, a group of blade servers, or a multi-processor system).

In some embodiments, the system 130 and the end-point device(s) 140 may have a client-server relationship in which the end-point device(s) 140 are remote devices that request and receive service from a centralized server, i.e., the system 130. In some other embodiments, the system 130 and the end-point device(s) 140 may have a peer-to-peer relationship in which the system 130 and the end-point device(s) 140 are considered equal and all have the same abilities to use the resources available on the network 110. Instead of having a central server (e.g., system 130) which would act as the shared drive, each device that is connect to the network 110 would act as the server for the files stored on it.

The system 130 may represent various forms of servers, such as web servers, database servers, file server, or the like, various forms of digital computing devices, such as laptops, desktops, video recorders, audio/video players, radios, workstations, or the like, or any other auxiliary network devices, such as wearable devices, Internet-of-things devices, electronic kiosk devices, mainframes, or the like, or any combination of the aforementioned.

The end-point device(s) 140 may represent various forms of electronic devices, including user input devices such as personal digital assistants, cellular telephones, smartphones, laptops, desktops, and/or the like, merchant input devices such as point-of-sale (POS) devices, electronic payment kiosks, and/or the like, electronic telecommunications device (e.g., automated teller machine (ATM)), and/or edge devices such as routers, routing switches, integrated access devices (IAD), and/or the like.

The network 110 may be a distributed network that is spread over different networks. This provides a single data communication network, which can be managed jointly or separately by each network. Besides shared communication within the network, the distributed network often also supports distributed processing. The network 110 may be a form of digital communication network such as a telecommunication network, a local area network (“LAN”), a wide area network (“WAN”), a global area network (“GAN”), the Internet, or any combination of the foregoing. The network 110 may be secure and/or unsecure and may also include wireless and/or wired and/or optical interconnection technology.

It is to be understood that the structure of the distributed computing environment and its components, connections and relationships, and their functions, are meant to be exemplary only, and are not meant to limit implementations of the disclosure described and/or claimed in this document. In one example, the distributed computing environment 100 may include more, fewer, or different components. In another example, some or all of the portions of the distributed computing environment 100 may be combined into a single portion or all of the portions of the system 130 may be separated into two or more distinct portions.

FIG. 1B illustrates an exemplary component-level structure of the system 130, in accordance with an embodiment of the disclosure. As shown in FIG. 1B, the system 130 may include a processor 102, memory 104, input/output (I/O) device 116, and a storage device 106. The system 130 may also include a high-speed interface 108 connecting to the memory 104, and a low-speed interface 112 (shown as “LS Interface”) connecting to low-speed expansion port 114 (shown as “LS Port”) and storage device 110. Each of the components 102, 104, 106 108, 110, and 112 may be operatively coupled to one another using various buses and may be mounted on a common motherboard or in other manners as appropriate. As described herein, the processor 102 may include a number of subsystems to execute the portions of processes described herein. Each subsystem may be a self-contained component of a larger system (e.g., system 130) and capable of being configured to execute specialized processes as part of the larger system.

The processor 102 can process instructions, such as instructions of an application that may perform the functions disclosed herein. These instructions may be stored in the memory 104 (e.g., non-transitory storage device) or on the storage device 106, for execution within the system 130 using any subsystems described herein. It is to be understood that the system 130 may use, as appropriate, multiple processors, along with multiple memories, and/or I/O devices, to execute the processes described herein.

The memory 104 stores information within the system 130. In one implementation, the memory 104 is a volatile memory unit or units, such as volatile random access memory (RAM) having a cache area for the temporary storage of information, such as a command, a current operating state of the distributed computing environment 100, an intended operating state of the distributed computing environment 100, instructions related to various methods and/or functionalities described herein, and/or the like. In another implementation, the memory 104 is a non-volatile memory unit or units. The memory 104 may also be another form of computer-readable medium, such as a magnetic or optical disk, which may be embedded and/or may be removable. The non-volatile memory may additionally or alternatively include an EEPROM, flash memory, and/or the like for storage of information such as instructions and/or data that may be read during execution of computer instructions. The memory 104 may store, recall, receive, transmit, and/or access various files and/or information used by the system 130 during operation.

The storage device 106 is capable of providing mass storage for the system 130. In one aspect, the storage device 106 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described above. The information carrier may be a non-transitory computer- or machine-readable storage medium, such as the memory 104, the storage device 106, or memory on processor 102.

The high-speed interface 108 manages bandwidth-intensive operations for the system 130, while the low-speed interface 112 manages lower bandwidth-intensive operations. Such allocation of functions is exemplary only. In some embodiments, the high-speed interface 108 (shown as “HS Interface”) is coupled to memory 104, input/output (I/O) device 116 (e.g., through a graphics processor or accelerator), and to high-speed expansion ports 111 (shown as “HS Port”), which may accept various expansion cards (not shown). In such an implementation, low-speed interface 112 is coupled to storage device 106 and low-speed expansion port 114. The low-speed expansion port 114, which may include various communication ports (e.g., USB, Bluetooth, Ethernet, wireless Ethernet), may be coupled to one or more input/output devices, such as a keyboard, a pointing device, a scanner, or a networking device such as a switch or router, e.g., through a network adapter.

The system 130 may be implemented in a number of different forms. For example, it may be implemented as a standard server, or multiple times in a group of such servers. Additionally, the system 130 may also be implemented as part of a rack server system or a personal computer such as a laptop computer. Alternatively, components from system 130 may be combined with one or more other same or similar systems and an entire system 130 may be made up of multiple computing devices communicating with each other.

FIG. 1C illustrates an exemplary component-level structure of the end-point device(s) 140, in accordance with an embodiment of the disclosure. As shown in FIG. 1C, the end-point device(s) 140 includes a processor 152, memory 154, an input/output device such as a display 156, a communication interface 158, and a transceiver 160, among other components. The end-point device(s) 140 may also be provided with a storage device, such as a micro-drive or other device, to provide additional storage. Each of the components 152, 154, 158, and 160, are interconnected using various buses, and several of the components may be mounted on a common motherboard or in other manners as appropriate.

The processor 152 is configured to execute instructions within the end-point device(s) 140, including instructions stored in the memory 154, which in one embodiment includes the instructions of an application that may perform the functions disclosed herein, including certain logic, data processing, and data storing functions. The processor may be implemented as a chipset of chips that include separate and multiple analog and digital processors. The processor may be configured to provide, for example, for coordination of the other components of the end-point device(s) 140, such as control of user interfaces, applications run by end-point device(s) 140, and wireless communication by end-point device(s) 140.

The processor 152 may be configured to communicate with the user through control interface 164 and display interface 166 coupled to a display 156. The display 156 may be, for example, a TFT LCD (Thin-Film-Transistor Liquid Crystal Display) or an OLED (Organic Light Emitting Diode) display, or other appropriate display technology. The display 156 may comprise appropriate circuitry and configured for driving the display 156 to present graphical and other information to a user. The control interface 164 may receive commands from a user and convert them for submission to the processor 152. In addition, an external interface 168 may be provided in communication with processor 152, so as to enable near area communication of end-point device(s) 140 with other devices. External interface 168 may provide, for example, for wired communication in some implementations, or for wireless communication in other implementations, and multiple interfaces may also be used.

The memory 154 stores information within the end-point device(s) 140. The memory 154 can be implemented as one or more of a computer-readable medium or media, a volatile memory unit or units, or a non-volatile memory unit or units. Expansion memory may also be provided and connected to end-point device(s) 140 through an expansion interface (not shown), which may include, for example, a SIMM (Single in Line Memory Module) card interface. Such expansion memory may provide extra storage space for end-point device(s) 140 or may also store applications or other information therein. In some embodiments, expansion memory may include instructions to carry out or supplement the processes described above and may include secure information also. For example, expansion memory may be provided as a security module for end-point device(s) 140 and may be programmed with instructions that permit secure use of end-point device(s) 140. In addition, secure applications may be provided via the SIMM cards, along with additional information, such as placing identifying information on the SIMM card in a non-hackable manner.

The memory 154 may include, for example, flash memory and/or NVRAM memory. In one aspect, a computer program product is tangibly embodied in an information carrier. The computer program product contains instructions that, when executed, perform one or more methods, such as those described herein. The information carrier is a computer- or machine-readable medium, such as the memory 154, expansion memory, memory on processor 152, or a propagated signal that may be received, for example, over transceiver 160 or external interface 168.

In some embodiments, the user may use the end-point device(s) 140 to transmit and/or receive information or commands to and from the system 130 via the network 110. Any communication between the system 130 and the end-point device(s) 140 may be subject to an authentication protocol allowing the system 130 to maintain security by permitting only authenticated users (or processes) to access the protected resources of the system 130, which may include servers, databases, applications, and/or any of the components described herein. To this end, the system 130 may trigger an authentication subsystem that may require the user (or process) to provide authentication credentials to determine whether the user (or process) is eligible to access the protected resources. Once the authentication credentials are validated and the user (or process) is authenticated, the authentication subsystem may provide the user (or process) with permissioned access to the protected resources. Similarly, the end-point device(s) 140 may provide the system 130 (or other client devices) permissioned access to the protected resources of the end-point device(s) 140, which may include a GPS device, an image capturing component (e.g., camera), a microphone, and/or a speaker.

The end-point device(s) 140 may communicate with the system 130 through communication interface 158, which may include digital signal processing circuitry where necessary. Communication interface 158 may provide for communications under various modes or protocols, such as the Internet Protocol (IP) suite (commonly known as TCP/IP). Protocols in the IP suite define end-to-end data handling methods for everything from packetizing, addressing and routing, to receiving. Broken down into layers, the IP suite includes the link layer, containing communication methods for data that remains within a single network segment (link); the Internet layer, providing internetworking between independent networks; the transport layer, handling host-to-host communication; and the application layer, providing process-to-process data exchange for applications. Each layer contains a stack of protocols used for communications. In addition, the communication interface 158 may provide for communications under various telecommunications standards (2G, 3G, 4G, 5G, and/or the like) using their respective layered protocol stacks. These communications may occur through a transceiver 160, such as radio-frequency transceiver. In addition, short-range communication may occur, such as using a Bluetooth, Wi-Fi, or other such transceiver (not shown). In addition, GPS (Global Positioning System) receiver module 170 may provide additional navigation- and location-related wireless data to end-point device(s) 140, which may be used as appropriate by applications running thereon, and in some embodiments, one or more applications operating on the system 130.

The end-point device(s) 140 may also communicate audibly using audio codec 162, which may receive spoken information from a user and convert it to usable digital information. Audio codec 162 may likewise generate audible sound for a user, such as through a speaker, e.g., in a handset of end-point device(s) 140. Such sound may include sound from voice telephone calls, may include recorded sound (e.g., voice messages, music files, etc.) and may also include sound generated by one or more applications operating on the end-point device(s) 140, and in some embodiments, one or more applications operating on the system 130.

Various implementations of the distributed computing environment 100, including the system 130 and end-point device(s) 140, and techniques described here can be realized in digital electronic circuitry, integrated circuitry, specially designed ASICs (application specific integrated circuits), computer hardware, firmware, software, and/or combinations thereof.

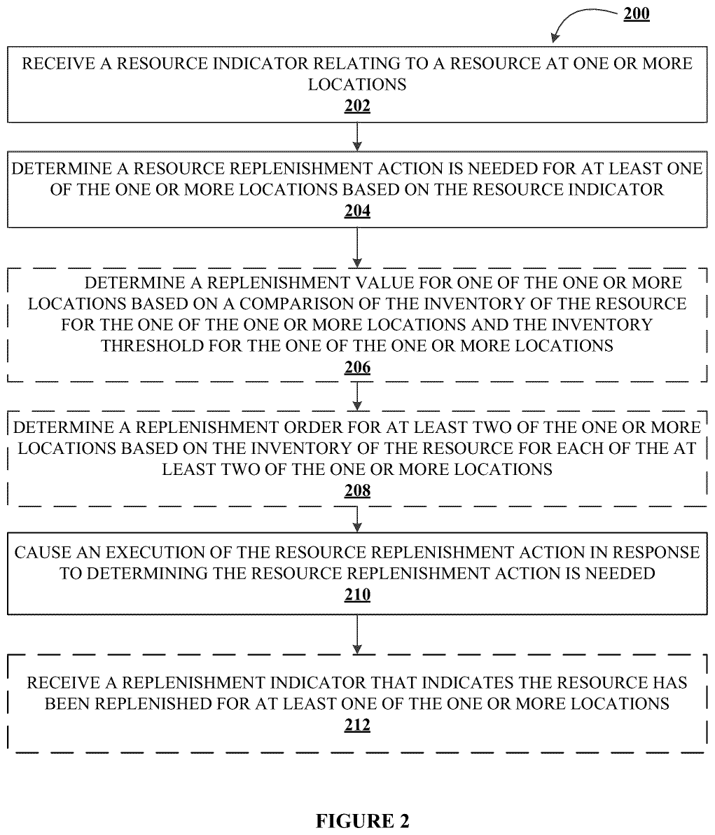

FIG. 2 is a flow chart 200 that illustrates another example method of electronically, initiating, tracking and completing resource replenishments with a network. The method may be carried out by various components of the distributed computing environment 100 discussed herein (e.g., the system 130, one or more end-point devices 140, etc.). An example system may include at least one non-transitory storage device and at least one processing device coupled to the at least one non-transitory storage device. In such an embodiment, the at least one processing device is configured to carry out the method discussed herein.

Referring now to Block 202 of FIG. 2, the method includes receiving a resource indicator relating to a resource at one or more locations. The resource indicator includes information relating to an inventory of the resource at each of the one or more locations. The resource may be any product and/or good that can be replenished. For example, the resource may be any item that is stocked at a location. For example, a resource may be an item at a merchant location. While the operations discussed herein are in reference to a single resource, the operations may be used for multiple different resources. Additionally, some resources may be grouped together (e.g., based on a common vendor) for monitoring purposes. For example, a resource replenishment action may be executed in an instance in which multiple grouped resources need to be replenished.

The resource indicator includes location specific information for the resource. The location may be an individual merchant, vendor, or other location in which a resource is located (e.g., a location may be a store in which the given product is sold or otherwise offered). While the locations discussed herein reference consumer-facing locations (e.g., merchants) and/or the like, a location may be any physical place in which a resource is located. For example, a location may be a warehouse that is used to distribute orders to consumers.

The resource indicator may be received in real-time (e.g., via an inventory tracking system or the like). Additionally or alternatively, the resource indicator may be received periodically (e.g., daily, weekly, monthly, etc.). The resource indicator may correspond to an individual resource or multiple resources. For example, the resource indicator may be for each resource in a given location or each resource received from a specific vendor.

Referring now to Block 204 of FIG. 2, the method includes determining a resource replenishment action is needed for at least one of the one or more locations based on the resource indicator. The resource replenishment action is needed in an instance in which the inventory of the resource is below an inventory threshold for at least one of the one or more locations. The inventory threshold is a minimum amount of the given resource for each location to possess at a given time. The inventory threshold may be set by the location operator (e.g., a merchant sets a minimum amount of the resource for the given location) or a vendor (e.g., a vendor may maintain a certain amount of the resource for the given location).

The inventory threshold may be different based on the individual location. For example, certain locations may have different capacity and/or demand for the resource affecting the inventory threshold for a given location (e.g., busier locations may have a higher inventory threshold for the resource to meet demand for the resource).

The resource replenishment action may be an alert to one or more suppliers that a replenishment is needed at least one of the one or more locations. The alert may include the resource, the location(s) needing replenishment, the current inventory for the location(s) needing replenishment, and/or various other information relating to the resource. The alert may be in the form of an automated message (e.g., email, phone message, text message, message provided via a graphical user interface, and/or other communications methods). The alert may include a request for approval that the resource needs to be replenished (e.g., a merchant or vendor may be prompted to confirm that the inventory of the resource is correct and/or whether a replenishment is necessary). The system may receive a confirmation that the replenishment is needed in response to the alert.

The resource replenishment action may include causing an automated resource order to be completed (e.g., an order for a resource replenishment may be authorized or recommended for approval). As discussed below in reference to optional Block 206 of FIG. 2, the method may include determining the number of resources needed for the resource replenishment. For example, the resource order may be based on the difference between the inventory value and the inventory threshold. Additionally or alternatively, the resource may have a standard resource order in response to falling below the inventory value (e.g., a set amount of resource units may be replenished in an instance in which the resource falls below the inventory threshold for a given location). The standard resource order may be preset by a vendor, supplier, merchant, and/or the like.

Referring now to optional Block 206 of FIG. 2, the method includes determining a replenishment value for one of the one or more locations based on a comparison of the inventory of the resource for the one of the one or more locations and the inventory threshold for the one of the one or more locations. Each location that needs replenishment may have an individual replenishment value. The replenishment value may be the amount of the resource to be replenished at a given location.

The replenishment value may be based on the difference between the inventory of the resource and the inventory threshold. Additionally or alternatively, the replenishment value may be based on the units of the resource that are offered by a supplier. For example, a supplier may provide a given resource in preset quantities and the replenishment value may be based on the preset quantities (e.g., the replenishment value may be the closest preset quantity to the difference between the inventory of the resource and the inventory threshold).

Referring now to optional Block 208 of FIG. 2, the method includes determining a replenishment order for at least two of the one or more locations based on the inventory of the resource for each of the at least two of the one or more locations. In various embodiments, the method may include scheduling replenishment of one or resources across multiple locations. For example, multiple locations may need replenishment at the same or similar time. Additionally, regular replenishments may also be prescheduled (e.g., a location may order have a monthly order for the given resource). In such an instance, the replenishment order may be adjusted based on scheduled replenishment (e.g., in an instance in which a pre-scheduled order is within a predetermined amount of time, a new replenishment order may not be necessary). Additionally, a scheduled replenishment may also be adjusted based on the features discussed herein. For example, in an instance in which an inventory of a given resource changes, the timing and/or number of resources in a scheduled replenishment may be adjusted (e.g., a scheduled replenishment may be moved to a sooner date than previously scheduled).

The method may also include determining replenishment order by determining a ranking of priority for replenishment among the locations needing a replenishment. For example, a resource may have a higher demand at a given location and therefore be given a higher priority than a location with a lower demand in an instance in which each location needs a replenishment. The replenishment order may be based on the coordinates of the locations (e.g., distance to a resource warehouse and/or distance to other location), the difference in the inventory of the resource from the inventory threshold (e.g., a higher difference in the inventory of the resource from the inventory threshold may cause a higher priority level), the amount of existing inventory (e.g., locations with little to no resources may be prioritized), and/or the like.

Referring now to Block 210 of FIG. 2, the method includes causing an execution of the resource replenishment action in response to determining the resource replenishment action is needed. The resource replenishment action is executed for each of the one or more locations in which the inventory of the resource is below the inventory threshold. As discussed above in reference to Block 204 of FIG. 2, the resource replenishment action may be transmitting an alert that one or more locations need to be replenished and/or scheduling and/or placing an automated replenishment order. The system may cause execution of the resource replenishment action based on determining that the inventory of a resource at one or more locations is below the inventory threshold for the given location.

The resource replenishment action may include a request for confirmation to execute a replenishment order. For example, the system may prompt a user to approve a new order (e.g., recommending a number of resources to be provided and/or requesting an input from the user for the number of resources to be provided).

Referring now to optional Block 212 of FIG. 2, the method includes receiving a replenishment indicator that indicates the resource has been replenished for at least one of the one or more locations. The replenishment indicator may be an updated inventory for one or more resources across one or more locations. For example, the replenishment indicator may be in the same form as the resource indicator discussed above in reference to Block 202 of FIG. 2.

In various embodiments, the replenishment indicator may include a notification that the replenishment has been completed, the updated value of the inventory of the resource for one or more of the one or more locations, the amount of the resource provided in the replenishment, the locations that were replenished, and/or the like. Additionally, the method may include requesting confirmation that the replenishment was executed (e.g., based on the replenishment indicator and/or based on a scheduled replenishment time).

As will be appreciated by one of ordinary skill in the art, various embodiments of the present disclosure may be embodied as an apparatus (including, for example, a system, a machine, a device, a computer program product, and/or the like), as a method (including, for example, a business process, a computer-implemented process, and/or the like), or as any combination of the foregoing. Accordingly, embodiments of the present disclosure may take the form of an entirely software embodiment (including firmware, resident software, micro-code, and the like), an entirely hardware embodiment, or an embodiment combining software and hardware aspects that may generally be referred to herein as a “system.” Furthermore, embodiments of the present disclosure may take the form of a computer program product that includes a computer-readable storage medium having computer-executable program code portions stored therein. As used herein, a processor may be “configured to” perform a certain function in a variety of ways, including, for example, by having one or more special-purpose circuits perform the functions by executing one or more computer-executable program code portions embodied in a computer-readable medium, and/or having one or more application-specific circuits perform the function.

It will be understood that any suitable computer-readable medium may be utilized. The computer-readable medium may include, but is not limited to, a non-transitory computer-readable medium, such as a tangible electronic, magnetic, optical, infrared, electromagnetic, and/or semiconductor system, apparatus, and/or device. For example, in some embodiments, the non-transitory computer-readable medium includes a tangible medium such as a portable computer diskette, a hard disk, a random access memory (RAM), a read-only memory (ROM), an erasable programmable read-only memory (EPROM or Flash memory), a compact disc read-only memory (CD-ROM), and/or some other tangible optical and/or magnetic storage device. In other embodiments of the present disclosure, however, the computer-readable medium may be transitory, such as a propagation signal including computer-executable program code portions embodied therein.

It will also be understood that one or more computer-executable program code portions for carrying out the specialized operations of the present disclosure may be required on the specialized computer include object-oriented, scripted, and/or unscripted programming languages, such as, for example, Java, Perl, Smalltalk, C++, SAS, SQL, Python, Objective C, and/or the like. In some embodiments, the one or more computer-executable program code portions for carrying out operations of embodiments of the present disclosure are written in conventional procedural programming languages, such as the “C” programming languages and/or similar programming languages. The computer program code may alternatively or additionally be written in one or more multi-paradigm programming languages, such as, for example, F #.

It will further be understood that some embodiments of the present disclosure are described herein with reference to flowchart illustrations and/or block diagrams of systems, methods, and/or computer program products. It will be understood that each block included in the flowchart illustrations and/or block diagrams, and combinations of blocks included in the flowchart illustrations and/or block diagrams, may be implemented by one or more computer-executable program code portions. These computer-executable program code portions execute via the processor of the computer and/or other programmable data processing apparatus and create mechanisms for implementing the steps and/or functions represented by the flowchart(s) and/or block diagram block(s).

It will also be understood that the one or more computer-executable program code portions may be stored in a transitory or non-transitory computer-readable medium (e.g., a memory, and the like) that can direct a computer and/or other programmable data processing apparatus to function in a particular manner, such that the computer-executable program code portions stored in the computer-readable medium produce an article of manufacture, including instruction mechanisms which implement the steps and/or functions specified in the flowchart(s) and/or block diagram block(s).

The one or more computer-executable program code portions may also be loaded onto a computer and/or other programmable data processing apparatus to cause a series of operational steps to be performed on the computer and/or other programmable apparatus. In some embodiments, this produces a computer-implemented process such that the one or more computer-executable program code portions which execute on the computer and/or other programmable apparatus provide operational steps to implement the steps specified in the flowchart(s) and/or the functions specified in the block diagram block(s). Alternatively, computer-implemented steps may be combined with operator and/or human-implemented steps in order to carry out an embodiment of the present disclosure.

While certain exemplary embodiments have been described and shown in the accompanying drawings, it is to be understood that such embodiments are merely illustrative of, and not restrictive on, the broad disclosure, and that this disclosure not be limited to the specific constructions and arrangements shown and described, since various other changes, combinations, omissions, modifications and substitutions, in addition to those set forth in the above paragraphs, are possible. Those skilled in the art will appreciate that various adaptations and modifications of the just described embodiments can be configured without departing from the scope and spirit of the disclosure. Therefore, it is to be understood that, within the scope of the appended claims, the disclosure may be practiced other than as specifically described herein.

What is claimed is:

1. A system for tracking and completing resource replenishments with a network, the system comprising:
at least one non-transitory storage device; and
at least one processing device coupled to the at least one non-transitory storage device, wherein the at least one processing device is configured to:
receive a resource indicator relating to a resource at one or more locations, wherein the resource indicator comprises information relating to an inventory of the resource at each of the one or more locations;
determine a resource replenishment action is needed for at least one of the one or more locations based on the resource indicator, wherein the resource replenishment action is needed in an instance in which the inventory of the resource is below an inventory threshold for at least one of the one or more locations; and
cause an execution of the resource replenishment action in response to determining the resource replenishment action is needed, wherein the resource replenishment action is executed for each of the one or more locations in which the inventory of the resource is below the inventory threshold.

2. The system of claim 1, wherein the at least one processing device is configured to receive a replenishment indicator that indicates the resource has been replenished for at least one of the one or more locations.

3. The system of claim 2, wherein the replenishment indicator includes an updated value of the inventory for one or more of the one or more locations.

4. The system of claim 1, wherein the at least one processing device is configured to determine a replenishment order for at least two of the one or more locations based on the inventory of the resource for each of the at least two of the one or more locations, wherein the replenishment order indicates a ranking of priority for replenishment among the at least two of the one or more locations.

5. The system of claim 1, wherein the at least one processing device is configured to determine a replenishment value for one of the one or more locations based on a comparison of the inventory of the resource for the one of the one or more locations and the inventory threshold for the one of the one or more locations.

6. The system of claim 1, wherein the resource replenishment action comprises an alert to one or more suppliers that a replenishment is needed at least one of the one or more locations.

7. The system of claim 1, wherein the resource indicator comprises a real-time value of the inventory of the resource at the one or more locations.

8. A computer program product for tracking and completing resource replenishments with a network, the computer program product comprising at least one non-transitory computer-readable medium having computer-readable program code portions embodied therein, the computer-readable program code portions comprising:
an executable portion configured to receive a resource indicator relating to a resource at one or more locations, wherein the resource indicator comprises information relating to an inventory of the resource at each of the one or more locations;
an executable portion configured to determine a resource replenishment action is needed for at least one of the one or more locations based on the resource indicator, wherein the resource replenishment action is needed in an instance in which the inventory of the resource is below an inventory threshold for at least one of the one or more locations; and
an executable portion configured to cause an execution of the resource replenishment action in response to determining the resource replenishment action is needed, wherein the resource replenishment action is executed for each of the one or more locations in which the inventory of the resource is below the inventory threshold.

9. The computer program product of claim 8, wherein the computer program product further comprises an executable portion configured to receive a replenishment indicator that indicates the resource has been replenished for at least one of the one or more locations.

10. The computer program product of claim 9, wherein the replenishment indicator includes an updated value of the inventory for one or more of the one or more locations.

11. The computer program product of claim 8, wherein the computer program product further comprises an executable portion configured to determine a replenishment order for at least two of the one or more locations based on the inventory of the resource for each of the at least two of the one or more locations, wherein the replenishment order indicates a ranking of priority for replenishment among the at least two of the one or more locations.

12. The computer program product of claim 8, wherein the computer program product further comprises an executable portion configured to determine a replenishment value for one of the one or more locations based on a comparison of the inventory of the resource for the one of the one or more locations and the inventory threshold for the one of the one or more locations.

13. The computer program product of claim 8, wherein the resource replenishment action comprises an alert to one or more suppliers that a replenishment is needed at least one of the one or more locations.

14. The computer program product of claim 8, wherein the resource indicator comprises a real-time value of the inventory of the resource at the one or more locations.

15. A computer-implemented method for tracking and completing resource replenishments with a network, the method comprising:
receiving a resource indicator relating to a resource at one or more locations, wherein the resource indicator comprises information relating to an inventory of the resource at each of the one or more locations;
determining a resource replenishment action is needed for at least one of the one or more locations based on the resource indicator, wherein the resource replenishment action is needed in an instance in which the inventory of the resource is below an inventory threshold for at least one of the one or more locations; and
causing an execution of the resource replenishment action in response to determining the resource replenishment action is needed, wherein the resource replenishment action is executed for each of the one or more locations in which the inventory of the resource is below the inventory threshold.

16. The method of claim 15, further comprising receiving a replenishment indicator that indicates the resource has been replenished for at least one of the one or more locations, wherein the replenishment indicator includes an updated value of the inventory for one or more of the one or more locations.

17. The method of claim 15, further comprising determining a replenishment order for at least two of the one or more locations based on the inventory of the resource for each of the at least two of the one or more locations, wherein the replenishment order indicates a ranking of priority for replenishment among the at least two of the one or more locations.

18. The method of claim 15, further comprising determining a replenishment value for one of the one or more locations based on a comparison of the inventory of the resource for the one of the one or more locations and the inventory threshold for the one of the one or more locations.

19. The method of claim 15, wherein the resource replenishment action comprises an alert to one or more suppliers that a replenishment is needed at least one of the one or more locations.

20. The method of claim 15, wherein the resource indicator comprises a real-time value of the inventory of the resource at the one or more locations.
